(19) United States
(12) Patent Application Publication
(10) Pub. No.: US 2009/0007822 A1
(43) Pub. Date: Jan. 8, 2009

(54) Electrostatically-Applicable, Heat-Fusable Powder Coatings and Additives

(76) Inventors: Neal S. Berke, Chelmsford, MA (US); Antonio J. Aldykiewicz, JR., Lexington, MA (US); Arnon Bentur, Haifa (IL); Mani Subramanian, Westford, MA (US)

Correspondence Address: W. R. GRACE & CO.-CONN;ATTENTION: PATENT DEPARTMENT, 62 WHITTMORE AVENUE, CAMBRIDGE, MA, 02140, US

(21) Appl. No.: 12/097,992

(22) PCT Filed: Dec. 5, 2006
(86) PCT No.: PCT/US06/46375

§ 371 Date: Jul. 15, 2008

Related U.S. Application Data
(60) Provisional application No. 60/752,670, filed on Dec. 21, 2005.

(51) Int. Cl. C04B 28/14

(52) U.S. Cl. 106/778

(57) ABSTRACT

Coatings for metal substrate surfaces comprise at least one film forming polymer is combined with microfine, substantially moisture-free cementitious particles. Preferred methods involve fusion bonded coating applications, wherein dry powder blends comprising polymer and the cementitious particles which preferably containing a corrosion inhibiting agent are electrostatically applied and heat-fused onto the metal.

### FIELD OF THE INVENTION

This invention pertains to the coating of metal objects and substrates, and more particularly to micro-fine cementitious-particle-containing electrostatically applicable, fusion-bondable powder coatings.

### BACKGROUND OF THE INVENTION

The present invention pertains to fusion-bondable coatings for protecting metal substrates. Such coatings are typically made from materials such as epoxy, polyurethane, polyesters, and polyacrylic resins and mixtures thereof, which can be cross-linked and fused to metal surfaces upon the application of high temperatures. Such coatings are used to protect metal from corrosion. Epoxy coatings provide a typical example of the use of fusion bonding.

Epoxy coatings are considered to be environmentally friendly in that they do not contain appreciable amounts of solvents or other hazardous components. Epoxy resin powder coating compositions capable of being cross-linked and various agents which effect the crosslinking are well known. Compositions having epoxy polymers and conventional crosslinking agents such as anhydrides or amines are also known (See e.g., U.S. Pat. No. 4,122,060).

Epoxy coatings are desirable for their ability to protect large steel objects, such as pipes and pipelines, against corrosion and mechanical damage, because continuous and durable films made by such coatings can be formed on metal surfaces. As epoxy is a thermoset material, it cures upon heating and does not tend to soften upon subsequent exposure to high temperatures. Thus, epoxy resists breakdown from weathering, exposure, chemical degradation, and other influences.

Commercially-available and widely-used coatings for steel include those known as fusion bonded epoxy (FBE) coatings. The process for applying FBE coatings to steel reinforcement involves four major steps: preparation of the surface, heating of the metal surface to above the fusion temperature of the epoxy resin, application of the epoxy resin powder, and curing of the epoxy resin.

For example, in many epoxy-coating plants, steel bars may be coated in straight form and then bent, or otherwise manipulated, into a final shape. Alternatively, it is possible to coat steel objects, such as shaped bars or welded wire mesh, after fabrication is completed. In either case, the epoxy maintains a film coating, which is continuous and free of openings, pores, or pinholes which could lead to corrosion of the underlying steel substrate.

Reinforcing steel, for example, is blast-cleaned to a near white metal finish using abrasive grit. This cleans the steel surface of contaminants and provides a rough surface for mechanically anchoring the corrosion-resistant epoxy coating and providing it with the opportunity to chemically bond with the steel. After blast-cleaning, the bars are heated to approximately 450° F. such as by using electrical induction heaters. The heated bars are passed through a powder spray booth where dry epoxy powder is emitted from a number of spray nozzles. As the powder leaves the spray nozzle, an electrical charge is imparted to the particles. The electrically charged particles are thus attracted to the hot steel, melt on its surface, flow into the anchor profile, and conform to the ribs and deformations of the reinforcing bar. The intense heat therefore initiates the chemical reaction causing the powder molecules to form complex cross-linked polymers, bestowing upon the epoxy coating its advantageous durability and protective properties.

As previously mentioned, the steel object or substrate may be heated either before application of the epoxy powder coating or heated after its application. As another example, a process for producing an FBE coating, as described in U.S. Pat. No. 3,904,346 of Shaw et al., involves the electrostatic spraying of the epoxy resin in powder form onto a preheated steel pipe that has been blast-cleaned. Shaw et al. also disclose a process involving shot blasting of the metal surface, subjecting the metal to a high-pressure fluid stream washing operation, polarizing the metal object, spraying the object with charged powdered resin (so as electrostatically to coat the object with the resin), and then curing the resin by heating the metal to above the fusion temperature of the resin.

An important measurable parameter directly relating to the performance of anti-corrosion coatings, such as epoxy, particularly for the protection of metal pipes and pipelines (such as those buried in the ground), is that of cathodic disbandment. This property is defined as the extent to which an anti-corrosion protective coating overlaying a metal surface will disbond as a result of a cathodic reaction, around a discontinuity in the protective coating (often referred to as a “holiday” or pinhole), in a cases wherein the pipe has been subjected to cathodic protection potentials in the soil environment.

Thus, cathodic protection has often been used to refer to the phenomenon of applying a small potential to a metallic pipeline that is buried in the ground (See e.g., U.S. Pat. No. 4,504,365 at col. 1, 11. 45 et seq.). The cathodic status of the buried pipeline will tend to limit, or protect against, corrosion that attacks the metal surface. Methods are known in the industry for measuring the extent to which a pipeline coating is cathodically disbanded (See e.g., ASTM G-8).

One of the primary objectives of the present invention is to provide compositions and methods for preventing or minimizing pinholing or porosity in anti-corrosion protective coatings on metal surfaces, which can lead to cathodic disbandment.

Another objective is to provide anti-corrosion protective coatings, such as fusion bonded film-forming polymer coatings that are electrostatically applied onto metal, and then heat-fused. Thus, pinholing is prevented, while speed of cure, flexibility, and adhesion retention are encouraged.

A still further objective is to provide compositions and methods that are convenient, economical, and adaptable to different techniques for applying continuous and durable coatings to metal objects and surfaces.

### SUMMARY OF THE INVENTION

The present invention provides polymer compositions and methods wherein cementitious particles, which are substantially devoid of free water, are used for preventing or minimizing cathodic disbondment when heat-fusing onto a metal substrate.

An exemplary heat-fusable composition for coating a metal substrate comprises at least one film-forming polymer present in an amount not less than 20% and not greater than 99% based on total weight of the composition; and cementitious particles having a mean particle size of 0.05-50.0 microns, more preferably 1-20 microns, and most preferably 5-10 microns. The particles should be substantially devoid of free water (or “moisture-free”) in that they contain free water in the amount of 0-2% based on total dry weight of the cementitious particles. The term “free water” is used to refer to water that does not participate in the cement hydration reaction and is therefore not chemically bound to cement reaction products. The cementitious particles are preferably in an amount of 1-50%, and more preferably 10-35%, based on total weight of the dry powder composition.

Optionally, the dry powder composition may comprise one or more conventional additives which may be present in an amount of 4-30% based on total weight of the dry powder composition and selected from the group consisting of a catalyst, curing agent, corrosion-inhibiting agent, accelerating agent, flow enhancement agent, pigment, colorant, defoaming agent, UV stabilizer, antioxidant, and non-cementitious filler.

The cementitious particles may therefore be hydrated, as disclosed in U.S. Pat. No. 6,648,962 of Berke et al., which describes a process involving hydration of Portland cement with one or more chemical admixtures (such as calcium nitrite which is a corrosion inhibiting agent) to form a hardened mass and subsequent crushing of the hardened mass to form particles. The present inventors discovered that such hydrated cementitious particles, wherein the water is chemically bound as a result of the hydration process, must be subsequently heated to remove substantially all of the free (non-hydration) water, such that the free water level is 0-2% by weight of particles. Otherwise, moisture loss from the cementitious particles can create voids in the coating during the heat-fusing operation, and this can lead to loss of anticorrosion protection.

In most preferred embodiments of the invention, the cementitious particles are formed by grinding Portland cement clinker that is essentially free of calcium sulfate (CaSO₄) and calcium sulfate hemihydrate (CaSO₄.2HOH), such that the resultant cement has low residual sulfate content. Preferably, the cementitious particles have a total sulfate content of 0.001% (or less) to no more than 0.1% by dry weight of the particles.

More surprisingly, the present inventors discovered that employing the microfine and substantially moisture-free cementitious particles (even without incorporation of an anticorrosion agent such as calcium nitrite) enhances cathodic disbondment resistance in a fusion-bondable polymer coating when the metal substrate is subjected to a cathodic current. Without being bound to theory, the inventors believed that the high surface area of the cementitious particles improves cathodic disbandment resistance, when the coated metal is subjected to corrosive conditions and/or to a cathodic current, due to an increase of localized pH within the layer coating due to alkalinity of the cementitious particles.

Examples of film-forming polymers that can be employed in the compositions and methods of the present invention include, without limitation, an epoxy resin, a polyester, a polyurethane, a polyacrylate, a vinyl polymer, a polyolefin, a polyamide, and mixtures thereof. Preferred compositions and methods involve the use of an epoxy resin or polyester-modified epoxy resin having the aforementioned cement particles. It is believed that microfine, substantially moisture-free cementitious particles are compatible with all resins and resin combinations used in powder coating systems. Given that coating performance does not depend on the resin system alone, but also on the primary pigments, extenders, and additives used, the microfine cementitious particles of the invention are believed to increase flexibility in powder coating systems because they can be designed to incorporate conventional additives that achieve specific results for a given coating system, or, as another feature, to incorporate an additive that may otherwise be incompatible with another additive used in the coating composition.

Additives that are conventionally used in the above-mentioned film-forming polymer coating compositions and methods may also be employed, including additives selected from the group consisting of a catalyst, curing agent, corrosion-inhibiting agent, accelerating agent, flow enhancement agent, pigment, colorant, defoaming agent, UV stabilizer, antioxidant, or mixture thereof. For example, a corrosion-inhibiting agent such as calcium nitrite may be incorporated into the coating composition, preferably by incorporation in the cementitious particles.

An exemplary method of the invention for making an electrostatically applicable dry powder coating composition comprises blending together (A) one or more film-forming polymers; (B) the afore-mentioned moisture-free cementitious particles; and (C) optionally one or more additives (e.g., curing agent, accelerator, pigment, inorganic filler, etc.); passing the mixture through a conventional extruder; and then reducing the mixture to a powder using conventional grinding equipment. Optionally, the particles should be sieved such that average and mean particle sizes are less than 250 microns.

Other embodiments of the invention involve a “package” composition, which is combinable with one or more film-forming polymers, to obtain a heat-fusable coating composition. An exemplary package composition comprises cementitious particles having a mean particle size of 1-50 microns, more preferably 1-20 microns, and most preferably 5-10 microns, the cementitious particles having a free water content of 0-2% based on total dry weight of cement particles, and one or more additives selected from the group consisting of non-cementitious filler, catalyst, curing agent, corrosion-inhibiting agent, accelerating agent, flow enhancement agent, pigments, colorants, defoaming agent, antioxidant agent, or a mixture thereof.

Exemplary methods of the invention comprise coating a surface of a metal substrate with the above-described coating composition having the at least one film-forming polymer or polymers and the substantially moisture-free cementitious particles. Preferably, the composition is applied as a dry powder, such as by electrostatic deposition, and fused to the metal surface by pre-heating the metal and/or applying heat to increase the temperature of the metal, whereupon the film-forming polymer contained in the powder will fuse to the metal and become cured.

The invention also provides metal articles, such as steel pipes or pipelines, steel bars and rebars, which are coated with the above-described coating compositions having the film-forming polymer or polymers and the substantially moisture-free cementitious particles. Indeed, the coating compositions are believed to have widespread automotive, industrial, and residential applications.

Further advantages and features of the invention are described in further detail hereinafter.

### DETAILED DESCRIPTION OF EXEMPLARY EMBODIMENTS

The present invention teaches compositions and methods wherein substantially moisture-free, microfine cementitious particles are employed in combination with at least one film-forming polymer to provide a coating composition, preferably applied in dry powder form (such as in electrostatic deposition), to a metal substrate surface and heat-fused thereon to provide an anticorrosion protective coating having excellent cathodic protection.

The term “cementitious” as used herein refers to particles made from a hydratable inorganic binder having a curing or hardening ability that is initiated upon the addition of and mixing with water. Exemplary cementitious materials suitable for use in the invention include Ordinary Portland Cement (OPC or “Portland cement” for short), pozzolans (e.g., fly ash, silica fume), granulated blast furnace slag, and mixtures thereof. A preferred cementitious material comprises a mixture of Portland cement and pozzolanic material that may be mixed in a ratio, for example, of 20:1 to 5:1.

In preferred embodiments, the cementitious particles are made by grinding a Portland cement clinker that is free of added calcium sulfate, which occurs as a natural hydrite (CaSO₄), and free too of added calcium sulfate hemihydrate, which is otherwise known as gypsum (CaSO₄.2HOH). The resultant cementitious particles will have a sulfate level that is lower than that of Ordinary Portland cement, which is otherwise made by grinding with gypsum in the manufacturing process used for making cement. In other embodiments, the cementitious particles are made using a Portland clinker having a sulfate content of 0.001-0.1%. Preferably, the clinker may also have at least one inorganic material selected from granulated blast furnace slag, fly ash, and silica fume. In Portland cement clinker that is free of added calcium sulfate and gypsum, the component tricalcium aluminate reacts directly with water to form 3CaO.Al₂O₃.6H₂O. This reaction is rapid, but the other components in the mixture do not react quickly enough to provide sufficient hardness for purposes of crushing and producing particles. However, when Portland cement clinker that is free of added calcium sulfate and gypsum is combined with calcium nitrite, the reaction product provided suitable hardness such that sufficient cementitious particles were formed when the hydrated material was crushed.

Accordingly, preferred embodiments of the invention involve cementitious particles that are made from grinding Portland cement clinker that is made without added calcium sulfate or gypsum but with a calcium, sodium, or potassium salt of a nitrite, nitrate, chromate, formate, molybdate, or mixture thereof. Preferred is calcium nitrite, calcium nitrate, calcium formate, or calcium molybdate, with calcium nitrite being most preferred.

In other exemplary embodiments, so-called “microcements” may be used to provide the microfine cementitious particles of the invention. These can be obtained commercially, are made with very low levels of free water, and are fine enough to be extruded into the coating compositions. Microcements are ground to a very small particle size in special mills, and are much finer than Ordinary Portland Cement. The use of such microcements is now widespread in Japan and North America for the grouting of fine grades of sands that are not practically groutable with ordinary grade cement grouts. Microcements are used extensively in Scandinavia for pre-injection of rock tunnels for consolidating, and thus water-sealing, the rocks. Microcements are generally based on Portland Cement clinker and sometimes contain blast furnace slag. The largest grain size of various microcements available are generally between 15 and 30 microns and have specific surface areas of between 600 and 1500 Blaine (m²/kg). (See “Specialty Cements—Uses and Applications In Civil Engineering And Underground Construction Works,” Franl (Papworth (Scancem Material) and Aage Rettvins (Scancem Chemicals)).

Regardless of the cement binder material, exemplary cementitious particles of the invention have a mean particle size of 0.01-50 microns, more preferably 1-20 microns, and most preferably 2-10 microns. The preferred mean particle size can well depend on personal preference, as well as the average size of the film-forming polymers used, and the method of application to the metal substrate surface to which the polymer is heat-fused. Conventional grinding equipment, such as air grinders (also known as air micromizers), ball mill grinders, jet mill grinders, and pearl mills (which employ zirconia grinding elements) can be used. For example, a jet mill grinder can be used to produce cementitious particles having a mean particle size between 2-10 microns (um), and an air classifier and sieve can be used to separate out particles having diameters below 2 um and above 10 um. Most preferably, the mean particle size is about 5-10 microns diameter.

The present inventors believe that it is possible to use commercially available microcements that are available in a form having 0-2% free water, and such microcements can be conveniently sieved or comminuted to obtain a most preferred mean particle size of 5-10 microns.

The term “free water” refers to water that is not part of the cement hydration process by which water becomes chemically bound with Portland cement. As mentioned in the summary above, the cementitious particles of the invention should be substantially devoid of free water in that they contain 0-2% free water, based on total weight of cement. For convenience, such particles may be alternatively referred to herein as “substantially moisture-free” or “substantially devoid of free water.”

If cementitious particles are prepared as taught in U.S. Pat. No. 6,648,962 B2 of Berke et al., which describes the optional incorporation of one or more admixtures), then the cementitious particles, after hydration and comminution, should be heated to at least 105° C. for a time sufficient to drive out free water moisture such that the amount of free water is no greater than two percent (2%) by total weight of the cement binder component. Optional admixtures may include calcium nitrite (preferred), calcium nitrate, or a mixture thereof, which is/are incorporated with the cement binder component before, during, or after mixing with water to initiate the hydration reaction and initiate the hardening process. Alternatively, or in addition, the admixture may be coated onto the outer surface of the cementitious particle as a liquid and partially absorbed into the particle.

In further exemplary embodiments, the cementitious particles may be comprised of cement having a negligible iron oxide content (typically <0.5% wt). Such a cement is commercially available as “white cement” and used where potential staining or darkening (due to iron content) is not desirable.

Exemplary compositions and methods of the invention comprise at least one a film-forming resin and the microfine, substantially moisture-free cementitious particles that may be applied, preferably in dry powder form, to coat a variety of metal substrates. In addition to steel pipes, steel pipelines, and rebar for concrete, the compositions may be applied to objects such as pipe hangers, valves, pumps, manifolds, ladders, mesh, cable and wire rope, I-beams, panels, column coils, anchor plates, chairs, and others.

In addition to the above-described microfine cementitious particles, exemplary compositions and methods of the invention further comprise at least one film-forming polymer which is operative to form a coating when applied, preferably as a dry powder (such as through electrostatic deposition), onto a metal substrate. The metal substrate may be pre-heated and/or heated after the powder coating is applied to achieve heat-fusing of the coating to the metal.

Exemplary film-forming polymers believed to be suitable for use in the invention may be selected from the group consisting of an epoxy resin, a polyester, a polyurethane, a polyacrylate, a vinyl polymer, a polyolefin, and a polyamide. More than one kind of polymer may be employed. Thermosetting resins such as epoxy, polyester, polyurethane, etc., are preferred. Various combinations of epoxy/polyester, epoxy/polyurethane, etc., may be employed as well.

Additives that are conventionally used with such polymers are also contemplated for use in the invention, as would be evident to those of ordinary skill in view of the disclosures herein. Exemplary additives might include a catalyst, curing agent, corrosion-inhibiting agent, accelerating agent, flow enhancement agent, pigment, colorant, defoaming agent, UV stabilizer, an antioxidant, or a mixture thereof.

Preferred film-forming polymers are epoxy compositions and systems because they are believed most convenient and suitable for the present invention, and are used in heat-fused coatings. Epoxy resins are thermosetting resins based on the reactivity of the epoxide group. One resin type is made from epichlorohydrin and bisphenol A. Aliphatic polyols such as glycerol may be used instead of the aromatic bisphenol A. For example, molecules of this type have glycidyl ether structures, have many hydroxyl groups, and cure readily with amines.

Another type of epoxy resin is made from polyolefins oxidized with peracetic acid. These have more epoxide groups, within the molecule as well as in terminal positions, and can be cured with anhydrides, but require high temperatures. Many modifications of both types are made commercially. Halogenated bisphenols can be used to add flame-retardant properties.

For protecting certain metal objects such as steel pipes, a fusion bonded epoxy powder is preferred. There are numerous powder coating systems based on epoxy or epoxy-novolac resins which are commercially available and which can be used in the coating compositions and methods of the present invention. Some examples include SCOTCHKOTE™ Fusion Bonded Epoxy Powders for corrosion protection of steel pipelines and metals used in the oil, gas, and construction markets. A variety of 3M™ SCOTCHCAST™ Powdered Resins are offered for OEM electrical insulation applications.

According to U.S. Pat. No. 4,122,060 of Du Pont, thermosetting epoxy powder coatings compositions may have finely divided particles at least 90 percent by weight of which has a maximum dimension not exceeding 150 microns, and preferably none has a dimension not exceeding 200 microns. It was described that preferably the maximum dimension should be 10-120 microns, and more preferable 40-100 microns.

The epoxy compositions of the invention also include epoxy novalak. These also are thermosetting resins, and are made by the reaction of epichlorohydrin with a novolac resin (phenol-formaldehyde). These have a repeating epoxide structure said to offer better resistance to high temperatures than epichlorohydrin-bisphenol A type.

The epoxy compositions of the invention may include other resin systems for modifying final properties of the coating as may be known in the epoxy art. For example, the epoxy compositions may include a polyolefin. The blending of epoxy resin and polyolefin into a powder coating mix applicable for forming protective composite coatings on metal substrates was disclosed, for example, in U.S. Pat. No. 5,178,902 of Wong et al. This patent described epoxy and epoxy-novolac resins, commercially available as 3M™ SKOTCHCOTE™ 206N Standard, 206N slow, NAPKO™ 7-2500, and VALSPAR™ D1003LD, which can be employed in a powder premixed with powdered polyethylene having a specific gravity range 0.915 to 0.965 with melt flow index ranges between 0.3 to 80 grams per 10 minutes. The polyolefin powder can be blended with additives such as UV stabilizers, antioxidants, pigments, and fillers (before being ground into a powder).

U.S. Pat. No. 3,578,615 of Moore et al. taught epoxy resin coatings providing cathodic disbanding resistance to metal surfaces. Moore et al. taught fluidizable, heat-curable, rapid-curing polyepoxide coating compositions consisting of (1) a polyepoxide possessing at least one vicinal epoxy group

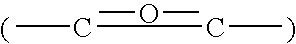

per molecule; (2) an epoxy curing agent; (3) an epoxy curing catalyst; (4) certain bonding additives such as ortho-nitrophenol, phosphoric acid, amino-silanes, and (5) fillers. It is believed that the substantially moisture-free cementitious particles described herein can be used in place of the filler portion.

Other epoxy resin systems may include polyesters, such as pure polyesters with hardeners containing epoxy groups or blocked isocyanates and acrylic resins with various cross-linking agents. The powders can be cured with dicyandiamide or polycarboxylic acids. Thus, an epoxy resin and acidic polyester resin in powder form may be used, and the mixing ratio can be 1:1 to 1:9 in favor of the polyester. Non-cementitious fillers may preferably be added into formulations for exterior applications employing polyester or polyurethane powders. Polyester powder coatings consist of acid polyester with a low-molecular weight hardener. The acrylic resins used in acrylic powder formulations contain glycidylmethacrylate, and react with carboxyl-functional cross-linking agents.

Thus, epoxy resin systems may include polyolefin, polyester, polyacrylate, or mixtures thereof for modifying properties of heat-fusable coatings for metal substrates. It will be appreciated by those of ordinary skill in the fusion bonded coating arts that such other film-forming polymer systems can be substituted for the epoxy-based resin systems in combination with the substantially moisture-free cementitious particles described herein. Hence, the present invention is framed generally in terms of a combination of at least one film-forming polymer generally in combination with the aforesaid cementitious particles. The epoxy-based resin systems provide a central, although not exclusive, embodiment for purposes of illustrating various aspects of the present invention.

An exemplary dry powder coating composition of the invention for heat-fusing to metal substrates comprises at least one film-forming polymer present in an amount not less than 20% and not greater than 99% based on total weight of the coating composition; cementitious particles having a mean particle size of 0.05-50.0 microns, more preferably 1-20 microns, and most preferably 5-10 microns, the particles being substantially devoid of free water in that they contain either no free water or water in an amount not exceeding 2% based on total dry weight of the cementitious particles, the cementitious particles being present in an amount of 1-50% (and more preferably 10-35%) based on total weight of the dry powder composition; the dry powder composition optionally comprising conventional additives, which may be present in an amount of 4-30% based on total weight of the dry powder composition and selected from the group consisting of a catalyst, curing agent, corrosion-inhibiting agent, accelerating agent, flow enhancement agent, pigment, colorant, defoaming agent, UV stabilizer, antioxidant, and non-cementitious filler.

Exemplary optional additives may include, such as when the film forming polymer is an epoxy system, a non-cementitious filler, catalyst, curing agent, corrosion-inhibiting agents, accelerating agents, flow enhancement agent, pigments, colorants, defoaming agent, antioxidant agents, and/or other agents or mixtures thereof.

Known non-cementitious organic and inorganic fillers may optionally be employed for modifying properties of the coating. Historically, additives were incorporated to improve abrasion resistance of the coating and to relieve shrinking forces which can occur during curing. Such additives include calcium carbonate, silica, mica, barium, sulfate, wollastonite, kaolin, titanium dioxide, sand, and mixtures thereof, incorporated in amounts of 0-80%, more preferably 5-50%, and most preferably 10-35%, based on total weight of the powder coating composition.

In conventional coating systems, the non-cementitious inorganic filler component may be replaced by the microfine, substantially moisture-free cement particles of the invention provide value-enhancing benefits such as the ability to deliver functional additives (e.g., pigments, colorants, corrosion-inhibiting agents) into the coating composition.

Exemplary corrosion inhibiting agents include calcium nitrite and/or nitrate, sodium nitrite and/or nitrate, sodium benzoate, certain phosphates, fluoroaluminates, fluorosilicates, amines, esters, molybdates, phosphates, fatty acid esters, borates (e.g. borax, sodium borate, potassium borate, lithium borate, and mixtures thereof. Such corrosion inhibiting agents may be employed in the amount of 0-50%, and more preferably 10-30%, based on dry weight of the cementitious particles.

Exemplary catalysts, curing agents, and/or accelerating agents for accelerating or achieving cross-linking particularly in epoxy or polyurethane systems) include dicyandiamide, polycarboxylic acids, polyfunctional amines, acid functional polyesters, isocyanate, and others. These may be used in amounts of 0-12%, more preferably 0.1-10%, and most preferably 0.2-8.0%, based on total weight of the coating composition.

Exemplary flow enhancement agents include acrylates (e.g., butyl acrylate preferably of high molecular weight, polyalkylacrylates). These may be used in amounts of 0-15%, more preferably 0.1-10%, and most preferably 0.5-5.0%, based on total weight of the coating composition.

Exemplary pigments and colorants include titanium dioxide, zinc oxide, iron oxide, chrome oxide, and the like, as well as metallic powders, metal hydroxides; sulfides; sulfates; and other filler pigments. These may be used in amounts of 0-80% and more preferably 0.1-60% based on total weight of the coating composition.

Exemplary defoaming agents include benzoin (which may also function as an epoxy catalyst agent), bisphenol A, phenyl acetyl salicylate, bisphenoxy propanol, and 1,4 cyclohexane dimethanol dibenzoate. These may be used in amounts of 0.5-5%, and most preferably 0.5-3%, based on total weight of the coating composition.

An exemplary method of the invention for making an electrostatically applicable dry powder coating composition comprises the step of blending together one or more film-forming polymer(s) (20-99%), the substantially moisture-free cementitious particles (1-50%), and optionally one or more additives (4-30%), all percentages based on total dry weight of the coating composition; passing the mixture through a conventional extruder; and then reducing the mixture into a powder. After being ground or milled into a powder, the coating composition may optionally be passed through a sieve to remove particles that are too large or too small. Preferably, a sieve which eliminates particles of maximum dimension greater than 150 microns can be used, but 40-55 percent by weight of the powder should preferably have a maximum dimension not exceeding 50 microns. The size and amount of the particles depend on the nature of the metal substrate or article being coated.

The invention also provides a “package” for combining with at least one film forming polymer to provide a heat-fusable coating composition. An exemplary package composition comprises (A) cementitious particles having a mean particle size of 1-50 microns, more preferably 1-20 microns, and most preferably 5-10 microns, the cementitious particles having a free water content of 0-2% based on total dry weight of cement particles, and (B) one or more additives selected from the group consisting of non-cementitious filler, catalyst, curing agent, corrosion-inhibiting agent, accelerating agent, flow enhancement agent, pigments, colorants, defoaming agent, antioxidant agent, or a mixture thereof. Such a package can be combined with the film-forming polymer system, such as a polyester or polyolefin, extruded together, and then ground to provide the coating composition.

Exemplary methods of the invention for forming a protective coating on a metal substrate, comprise coating a metal substrate with the aforementioned coating composition having the microfine, substantially moisture-free cementitious particles and at least one film-forming polymer, and at least one optional additive comprising a non-cementitious filler, catalyst, curing agent, accelerating agent, flow enhancement agent, pigment, colorant, defoaming agent, or mixture thereof.

A preferred dry powder composition of the invention for heat-fusing to metal substrates, comprises: a plurality of polymer-cementitious particles comprising a blend of at least one film-forming polymer and substantially moisture-free cementitious particles, the polymer/cementitious particles having a mean particle size of 20-500 microns (and more preferably 30-300 microns); the at least one film-forming polymer being present in an amount of 20%-99% based on total weight of the composition and being selected from the group consisting of an epoxy resin, a polyester, a polyurethane, a polyacrylate, a vinyl polymer, a polyolefin, and a polyamide; and the cementitious particles having a mean particle size of 0.05-20.0 microns (and more preferably 5-10 microns) and being substantially devoid of free water in that they contain either no free water or water in an amount not exceeding 2% based on total dry weight of the cementitious particles, which are present in an amount of 10%-35% based on total weight of the dry powder composition; and the cementitious particles comprising at least one corrosion inhibiting agent selected from the group consisting of a nitrite (e.g., calcium nitrite), nitrate, chromate, and phosphate.

The coating compositions, which are preferably in dry powder form, may be applied to the metal substrate by electrostatic spraying techniques (See e.g., U.S. Pat. No. 3,904,346 of Shaw et al. and U.S. Pat. No. 5,178,902 of Wong et al.), or by using a fluidized bed, which can be electrostatic, as known in the art. The coating compositions may be applied directly to the metal surface, although for some end-uses a primer can be used. It is preferable that the surface to be coated be first cleaned, such as, for example, by grinding or grit blasting.

Coating composition can be applied either in one pass or in several passes to provide variable thicknesses, after cure, of 0.2-0.5 mm., depending on the desired end-use of the coated article. Some pipes, for example, which are to be buried underground, require a coating thickness of approximately 0.2-0.8 mm.

The present invention also pertains to methods for coating metal articles and substrates with the above-described coating compositions, as well as to the metal articles coated by such coating compositions. Preferably, the metal object or substrate surface is heated, either before or after contact with the film-forming resin composition (e.g., epoxy resin/microfine cementitious particle mixture) whereby the epoxy composition is heat-fused to the metal.

In a preferred method, a metal object, such as a steel pipe or pipeline, is electrostatically coated with a coating composition comprising an epoxy resin and the substantially moisture-free cementitious particle dry powder composition that optionally contains at least one additive, such as calcium nitrite, a non-cementitious filler, catalyst, curing agent, accelerating agent, flow enhancement agent, pigment, colorant, defoaming agent, or mixture thereof and the coating composition is then fused on the metal surface by heating the pipe/pipeline to a temperature sufficient to soften the film forming polymer.

The present invention also pertains to powder-coated metal articles using the coating compositions described above. Particularly promising applications include the automotive (and other general transportation) and industrial baking finishes areas. For example, the industrial powder coating applications can include building and construction uses as well as farm and agricultural applications. In the building area alone, it is believed that the powder coating compositions of the present invention can be used for coating aluminum or steel doors and door frames, window frames and sashes, siding, and garage doors. In the farm and agricultural area, coating compositions can be used for power equipment (tractors, lawn mowers, power tools), as well as for metal implements, tools, sheds, fenceposts, etc., that are exposed to outdoor weather. In the automotive area, a variety of parts for cars, buses, trucks, and train cars can be powder coated for anticorrosion protection. The coatings may also be used on indoor metal objects such as office furniture, filing cabinets, and the like.

The following examples are provided for illustrative purposes only, and various other embodiments, modifications, and variations may become evident to those of ordinary skill in view of the disclosures herein.

### Example 1

Cementitious material can be prepared using ordinary Portland cement (OPC) as well as OPC with calcium nitrite. The particles are made by mixing the cement with water to form a hardened mass which is crushed, after hardening, between rollers to produce an initial feed material. The particles should then be heated at around 105° C. to drive out free water to a level of 0-2% by total weight of the cementitious particles.

The cementitious feed material can be fed into a fluid bed jet mill capable of achieving dense phase micronization by turbulent free jets in combination with high efficiency centrifugal air classification within a common housing. Such jet mills are available from CCE Technologies, Inc., of Cottage Grove, Minn., and are used for processing various materials including powder coating materials.

The cementitious feed material, which is in the form of large particles, is introduced into the housing of the jet mill through either a double flapper valve or injector and downward into a pulverizing zone, in which air-driven jet nozzles are used to accelerate the particles for impact and breakage into finer particles. After impact, the fluid and size-reduced particles leave the fluid bed and travel upwards to a centrifugal classifier having rotors whose speed will define what size particles will continue with the fluid through the rotor and which will be rejected back into the particle bed below for further size reduction. A high degree of particle dispersion leaving the pulverizing zone aids in the efficient removal of fine particles by the classifier. By adjusting rotor speed, nozzle pressure, and bed level, the operator can optimize productivity, product size, and distribution shape of the particle sizes.

By using such jet mill, it is possible to obtain mean particle sizes of cementitious material that are in a preferred 2-10 micron sized range. Particles that are less than 2 microns can be removed, while particles that are larger than 10 microns can be re-milled. A distribution of particle size can be achieved, for example, whereby the mean particle size is between 4-6 microns, and these particles would be suitable microfine cementitious particles of the invention.

In further exemplary embodiments of the invention, a dryer unit can be used in the air classifier or after the air classifier to drive off free water content in the cementitious particles, or otherwise to guarantee that the free water content of such cementitious particles is as low as possible and in any event not greater than 2% by weight.

### Example 2

Exemplary dry powder coating compositions of the invention can be provided by combining microfine powders provided by Example 1, or alternatively (but less desired) using microcements, and at least one film forming polymer, such as epoxy-based polymers.

It is believed that a wide array of epoxy systems may be used with the micro-fine substantially moisture-free cementitious particles to provide heat-fusable dry powder coating compositions.

For example, U.S. Pat. No. 3,578,615 of Moore et al. disclosed various fluidizable, heat-curable, rapid-curing polyepoxide coating compositions having improved cathodic disponding resistance, and is incorporated as if fully set forth herein. These coatings included (1) a polyepoxide possessing at least one vicinal epoxy group per molecule; (2) an epoxy curing agent; (3) an epoxy curing catalyst; (4) certain bonding additives such as ortho-nitrophenol, phosphoric acid, amino-silanes, and (5) fillers. According to Moore, the epoxy resin contains at least one vicinal epoxy group

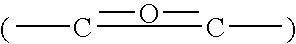

which may be in a terminal or internal position within the molecule, and may be saturated or unsaturated, aliphatic, cycloaliphatic, aromatic or heterocyclic, and may be substituted with substituents such as chlorine, hydroxyl groups, ether radicals, and the like.

Those of ordinary skill in the powder coating arts will select the appropriate epoxy resin or combination of epoxy resins, curing agent, catalyst, and bonding additives, based on melting point, molecular weight, and other characteristics, depending on the metal substrate being coated and amount of the microfine, substantially moisture-free cementitious particles desired to be incorporated.

### Example 3

Epoxy coating compositions similar to that used in reinforcing bar coatings were formulated using various amounts of low molecular weight epoxy resin (KD 214), medium weight epoxy resin (KD 404), benzion (a degassing/catalytic agent), a flow control agent (available from Worlee under the tradename “RESIFLOW™ PL-200), and curing agent (brandname KRT-12). Sample 1 was a control, Samples 2-3 employed cementitious particles made from Ordinary Portland Cement (OPC/<2% free water) in amounts between 10% and 30% by weight, and Samples 4-7 employed cementitious particles made from OPC and calcium nitrite (“OPC/CANI”). The cementitious particles used in Samples 2-7 were dried until there was no further mass reduction at 105° C. The formulations for samples 1-7 are shown in Table 1 below.

TABLE 1

| Components | 1 | 2 | 3 | 4 | 5 | 6 | 7 |
|---|---|---|---|---|---|---|---|
| KD 214 resin | 0.70 | 0.63 | 0.55 | 0.48 | 0.63 | 0.55 | 0.48 |
| KD 404 resin | 0.23 | 0.21 | 0.18 | 0.16 | 0.21 | 0.18 | 0.16 |
| PL-200 | 0.01 | 0.01 | 0.01 | 0.01 | 0.01 | 0.01 | 0.01 |
| Benzoin | 0.01 | 0.01 | 0.01 | 0.01 | 0.01 | 0.01 | 0.01 |
| KRT-12 | 0.05 | 0.05 | 0.05 | 0.05 | 0.05 | 0.05 | 0.05 |
| OPC | | 0.01 | 0.20 | 0.30 | | | |
| OPC/CANI | | | | | 0.10 | 0.20 | 0.30 |
| Total | 1.00 | 1.00 | 1.00 | 1.00 | 1.00 | 1.00 | 1.00 |

Each of the sample coatings were successfully applied onto a steel sheet. While these epoxy coatings samples were not optimized for continuous production operations, they confirmed that it was possible to load the cementitious particles up to 30% by total weight of the particles. The inventors believe that further formulation work would allow loadings up to 35% without too much modification, although the inventors did confirm that loadings of 30% would be more preferably for brittle coatings (for monolithic objects such as bars and panels which have relatively flatter surfaces). It is believed that even 50% loading by weight of cementitious particles might be possible if factors such as particle distribution, level and type of flow control agents, types and average molecular weight of resins, and other factors were modified.

For example, the flow control agent (RESIFLOW™ PL-200) employed above is a silicone free, acrylic flow control agent designed for epoxy-, polyester-, acrylic resin, hybrid, and other powder coating compositions. According to the technical literature (“revision: 04.04.05”), this agent is said to improve adhesion to substrates, deairing, flow and recoatability, and avoids surface imperfections such as craters, pinlioles, and peeling. Although tests were done above in which 1% of the flow control agent was added, the literature for RESIFLOW PL-200 indicates that the optimum addition is between 0.5-1.5%, and that this flow control agent should be pre-blended with other coating ingredients in a high intensity mixer and homogenized in an extruder. If other epoxy resins or other resins or other resin combinations are employed, the compatability of powdering coatings and the flow control agent is an important factor to be considered. Nonetheless, given that there are numerous flow control agents that are commercially available and known in the art, the inventors believe that a suitable electrostatically-applicable epoxy-based dry powder coating can easily be produced as part of a continuous production operation that can be used for coating metal substrates such as steel reinforcing bars, sheets, beams, and other objects.

Each of seven steel sheets were coated with a different one of the seven respective coating samples shown in Table 1 and subjected to accelerated corrosion testing. The coating was scratched (in a straight line), and the sample submerged in water having chloride content (15% NaCl solution to simulate concrete pore water) for several months. A more controlled machined “X”-shaped grooves that were 15 mm long by 1 mm wide was produced for a second series of testing in which the steel panels were covered with a thin 5 mm mortar with additional mortar chunks placed in the liquid to maintain an environment similar to concrete. (The mortar cover would keep the scratches from coming into direct contact with the solution, simulating a concrete exposure with a cut in the coating). The sheets were subjected to macrocell current differential to initiate corrosion. After several months, it was confirmed that the treated samples (Samples 2-7 of steel sheets coated with the coating compositions having either OPC or OPC/CANI particles) outperformed the control sample.

### Example 4

The inventors believe that even better results than obtained in Example 3 can be realized by substituting for the OPC and OPC/CANI particles (as described in Example 1) improved cementitious particles made from Portland cement clinker made from calcium nitrite instead of calcium sulfate or calcium sulfate hemihydrate (gypsum) and calcium nitrite. This is because sulfate contributes to corrosion, and thus by avoiding addition of sulfate to the cementitious particles will presumably increase the anti-corrosion performance of the resultant coating composition.

### Example 5

An exemplary polyester-based powder coating composition can be made by coextruding together the following components:

| | Sample 1 | Sample 2 |
|---|---|---|
| | (wt | (wt |
| Components | proportion) | proportion) |
| Polyester (Crylcoat ® 430) | 629.4 | 653.2 |
| Polyester (Crylcoat ® 108) | 62.9 | 65.4 |
| Crosslinker (e.g., triglycidyl | 52.1 | 54.1 |
| isocyanurate) (e.g., TGIC | | |
| (Araldit ® PT810, Ciba) | | |
| Catalyst | 1.5 | 1.6 |
| (e.g, Benzoin - g., Fluka AG) | | |
| Pigment | — | 21.9 |
| (e.g., Titandioxid ® TYP 2160 | | |
| (Kronos GmbH)) | | |
| Other Additives: | — | 21.9 |
| (e.g., IRGACOR ® 252 LD) | | |
| Microfine Cementitious Particles | 107.5 | 113.5 |
| (e.g., made by Examples 1 or 4) | | |

The additive IRGACOR® 252 LD is 2-Benzothiazolylthio succinic acid available from Ciba Specialty Chemicals as a low dust product for use in powder coating applications, and may be preblended with the microfine cementitious particles of the invention. This combination in the coating, particularly if the microfine cementitious particles are made from Portland cement clinker made using calcium nitrite and without added calcium sulfate and without added gypsum are believed operative to prevent filiform corrosion (untreated aluminum surfaces).

### Example 6

Another exemplary polyester-based powder coating composition can be made by coextruding together the following components as shown in Table 2 below:

TABLE 2

| Components | wt % |
|---|---|
| Polyester (Hoechst AN 725) | 51.1 |
| Crosslinker (TEPIC ™ G) | 3.8 |
| Flow Agent (RESIFLOW ™ P-67) | 1.2 |
| WAX (AC-8A) | 0.2 |
| Degassing Agent (Benzoin) | 0.4 |
| Antioxidant (Irganox ™ 1076 from Ciba) | 0.2 |
| Pigment (Titanium Dioxide - e.g., RTC-4) | 22.0 |
| Inhibitive Pigment (e.g., MOLY-WHITE ® ZNP) | 10.0 |
| Microfine Cementitious Particles (made by | 11.1 |
| Examples 1 or 4 | |
| | 100.0 |

The above example is a starting formulation of the Moly-White Pigments Group of Cleveland, Ohio, except that the microfine, moisture-free cementitious particles made by examples 1 or 4 are substituted for ordinary filler (which was in this case calcium carbonate). Certainly, the amount of cementitious particles can be decreased from the 11.1% indicated above in Table 2 by substituting back in the calcium carbonate filler, and the amount of the cementitious particles can be increased such as by, for example, substituting for portions of the pigments.

This kind of application may also benefit from using “white cement” in the cementitious particles, because such white cement has negligible iron oxide content which would otherwise stain or darken the coating.

### Example 7

The microfine moisture-free cementitious particles can be preblended with one or more components of conventional powder coating compositions.

For example, the cementitious particles can be melt-blended together with the resin and shipped in encapsulated form to a powder coating manufacturer, who may then combine this preblend with its own selected curing agents, catalysts, flow control agent, and other agents to obtain the final coating formulations.

The foregoing examples are provided for illustrative purposes only and are not intended to limit the scope of the invention.

It is claimed:

1. A heat-fusable composition for coating a metal substrate, comprising:
at least one film-forming polymer present in an amount not less than 20% and not greater than 99% based on total weight of the composition; and
cementitious particles having a mean particle size of not less 0.05 microns and not greater than 20 microns, said particles being substantially devoid of free water in that they contain no free water in the amount of 0-2% based on total dry weight of said cementitious particles.

2. The composition of claim 1 wherein said at least one film-forming polymer is selected from the group consisting of an epoxy resin, a polyester, a polyurethane, a polyacrylate, a vinyl polymer, a polyolefin, and a polyamide.

3. The composition of claim 2 comprising at least two film-forming polymers.

4. The composition of claim 2 wherein said cementitious particles are present in an amount no less than 1% and no greater than 50% based on total weight of the dry powder composition.

5. The composition of claim 4 wherein
said at least one film-forming polymer present in an amount not less than 30% and not greater than 95%; and
said composition further comprises at least one additional additive, present in an amount no less than 4% and no greater than 30% based on total weight of the composition, said at least one additional additive comprising a catalyst, curing agent, corrosion-inhibiting agent, accelerating agent, flow enhancement agent, pigment, colorant, defoaming agent, UV stabilizer, antioxidant or mixture thereof.

6. The composition of claim 2 wherein said at least one film-forming polymer is an epoxy resin.

7. The composition of claim 6 wherein said epoxy resin further comprises polyester.

8. The composition of claim 2 wherein said at least one film-forming polymer is a polyester.

9. The composition of claim 8 wherein said at least one film-forming polymer is a polyester further having an epoxy resin hardener.

10. The composition of claim 2 wherein said at least one film-forming polymer is a polyurethane.

11. The composition of claim 2 wherein said at least one film-forming polymer is a polyacrylate.

12. The composition of claim 2 wherein said at least one film-forming polymer is a vinyl polymer.

13. The composition of claim 2 wherein said vinyl polymer is selected from the group consisting of polyvinyl chloride, polyvinylidene chloride, and polyvinylidene flouride.

14. The composition of claim 2 wherein said at least one film-forming polymer is a polyolefin.

15. The composition of claim 13 wherein said polyolefin is a polyethylene, a polypropylene, or blend thereof.

16. The composition of claim 2 wherein said at least one film-forming polymer is a polyamide.

17. The composition of claim 1 wherein said cementitious particles are prepared by providing Portland cement, hydrating said cement to form a hardened mass, comminuting said hardened cement mass into particles having a mean particle size of not less 0.05 microns and not greater than 20 microns, and heating said cement particles to drive off free water to a level no greater than 2% by weight of said cementitious particles.

18. The composition of claim 1 wherein said cementitious particles are formed by grinding Portland cement clinker that is essentially free of calcium sulfate (CaSO₄) and calcium sulfate hemihydrate (CaSO₄.2HOH).

19. The composition of claim 18 wherein said Portland cement clinker is made from a calcium, sodium, or potassium salt of a nitrite, nitrate, chromate, formate, molybdate, ester, phosphate, borate, or mixture thereof.

20. The composition of claim 18 wherein said Portland cement clinker is made from a calcium nitrite, calcium nitrate, or mixture thereof.

21. The composition of claim 18 wherein said at least one film forming polymer is selected from the group consisting of an epoxy resin, a polyester, a polyurethane, a polyacrylate, a vinyl polymer, a polyolefin, and a polyamide; and
said provided Portland cement is made by grinding Portland cement clinker with essentially no calcium sulfate or calcium sulfate hemihydrate.

22. The composition of claim 18 wherein said cementitious particles comprise Portland cement having a sulfate content of 0.001-0.1% and at least one inorganic material selected from granulated blast furnace slag, fly ash, and silica fume.

23. The composition of claim 1 wherein said cementitious particles are microcement.

24. The composition of claim 1 further comprising one or more conventional additives selected from the group of catalyst, curing agent, corrosion-inhibiting agent, accelerating agent, flow enhancement agent, pigment, colorant, defoaming agent, UV stabilizer, antioxidant, or mixture thereof.

25. The composition of claim 1 wherein said cementitious particles comprise Portland cement comprising combining calcium nitrite with clinker having no added calcium sulfate or calcium sulfate hemihydrate.

26. A composition for modifying a polymeric, heat-fusable coating, comprising:
cementitious particles having a mean particle size of not less 0.05 microns and not greater than 20 microns, said particles being substantially devoid of free water in that they contain free water in an amount of 0-2% based on total dry weight of said cementitious particles; of said cement particles; and
at least one non-cementitious filler, catalyst, corrosion-inhibiting agent, curing agent, accelerating agent, flow enhancement agent, pigments, colorants, defoaming agent, or mixture thereof.

27. A method for making a coating composition, comprising:
blending together at least one film-forming polymer in an amount not less than 20% and not greater than 99% based on total weight of the coating composition; and
cementitious particles having a mean particle size of not less 0.05 microns and not greater than 20 microns, said particles being substantially devoid of free water in that they contain either no free water or water in an amount not exceeding 2% based on total dry weight of said cementitious particles, said cementitious particles being present in an amount not less than 1% and no greater than 50% based on dry weight of said coating composition;
passing said at least one film forming polymer and said cementitious particles through an extruder to form an extrudate material; and
reducing said extrudate material into individual particles having a mean particle size of 30-500 microns.

28. Method for forming a protective coating, comprising: coating a metal substrate with the composition of claim 1.

29. Method of claim 28 further comprising heating said metal object or substrate before or after application of said composition.

30. Method of claim 29 further comprising depositing said coating on a metal substrate using electrostatic attraction and heat-fusing said coating thereon to form a continuous coating.

31. A metal object coated with the composition of claim 1.

32. A heat-fusable composition for coating a metal substrate, comprising:
a plurality of polymer/cementitious particles comprising a blend of at least one film-forming polymer and cementitious particles, said polymer/cementitious particles having a mean particle size no less than 20 microns and no greater than 500 microns;
said at least one film-forming polymer being present in an amount not less than 20% and not greater than 95% based on total weight of the composition, said at least one film forming polymer being selected from the group consisting of an epoxy resin, a polyester, a polyurethane, a polyacrylate, a vinyl polymer, a polyolefin, and a polyamide; and
said cementitious particles having a mean particle size of not less 0.05 microns and not greater than 20 microns, said cementitious particles being substantially devoid of free water in that they contain free water in an amount of 0-2% based on total dry weight of said cementitious particles, cementitious particles being provided by grinding Portland cement clinker that is free of added calcium sulfate (CaSO₄) and calcium sulfate hemihydrate (CaSO₄.2HOH), and said cementitious particles being present in an amount no less than 10% and no greater than 35% based on total weight of the dry powder composition; and
said cementitious particles comprising at least one corrosion inhibiting agent comprising a nitrite, nitrate, benzoate, phosphate, fluoroaluminate, fluorosilicate, amine, ester, molybdate, fatty acid ester, borate, or mixture thereof.

33. A metal article having a heat-fused coating made from the composition of claim 30.
